(19) United States
(12) Patent Application Publication
(10) Pub. No.: US 2004/0092183 A1
(43) Pub. Date: May 13, 2004

(54) Antiballistic composite material comprising combinations of distinct types of fibers

(76) Inventors: Shalom Geva, Holon (IL); Yuval Fuchs, Netanya (IL)

Correspondence Address: WINSTON & STRAWN, PATENT DEPARTMENT, 1400 L STREET, N.W., WASHINGTON, DC, 20005-3502, US

(21) Appl. No.: 10/357,256

(22) Filed: Feb. 3, 2003

Related U.S. Application Data
(60) Provisional application No. 60/426,075, filed on Nov. 13, 2002.

(30) Foreign Application Priority Data
Nov. 12, 2002 (IL) 152806

(51) Int. Cl. B32B 27/12; B32B 5/02; B32B 5/26; B32B 25/02; B32B 25/10; B32B 27/04

(52) U.S. Cl. 442/134; 428/911; 442/135; 442/239; 442/243; 442/254; 428/295.1

(57) ABSTRACT

The present invention relates generally to the field of ballistic resistant composite materials that are made of a plurality of monolayers of ballistic resistant polymer fibers. More particularly, this invention relates to composite materials having improved antiballistic protection and that include at least two distinct types of polymeric fibers, and preferably including poly-(p-phenylenebenzobisoxazole), aramid or polyethylene fibers. The invention also is directed to various methods of making these ballistic resistant materials and to body armor containing the same.

### CROSS-REFERENCE TO RELATED APPLICATIONS

This application claims the benefit of provisional application 60/426,075 filed Nov. 13, 2002.

### FIELD OF THE INVENTION

The present invention relates generally to the field of ballistic resistant composite materials, comprising a plurality of monolayers comprising ballistic resistant polymer fibers. More particularly, this invention relates to composite materials having improved antiballistic protection comprising at least two distinct types of polymeric fibers, preferably including poly-(p-phenylenebenzobisoxazole), aramid or polyethylene fibers.

### BACKGROUND OF THE INVENTION

Numerous types of antiballistic articles are known, including bulletproof vests, helmets, structural members of helicopters, vehicle panels and other military equipment containing high strength fibers. Polymeric fibers that are generally used for the preparation of such antiballistic articles include, for example, aramid fibers, polyethylene fibers, graphite fibers, nylon fibers, ceramic fibers, glass fibers and the like.

U.S. Pat. Nos. 4,403,012 and 4,457,985 disclose ballistic resistant composite articles comprising networks of high molecular weight polyethylene or polypropylene fibers, and matrices composed of olefin polymers and copolymers, unsaturated polyester resins, epoxy resins, and other resins curable below the melting point of the fiber.

U.S. Pat. Nos. 4,623,574 and 4,748,064 disclose a simple composite structure which comprises a network of high strength polyethylene fibers exhibiting an outstanding ballistic protection having a tensile modulus greater than 500 gram/denier and an energy-to-break of at least about 22 Joules/gram.

Particularly effective fibers made from ultrahigh molecular weight polymers, such as polyethylene and polypropylene, in a relatively non-volatile solvent are disclosed in U.S. Pat. No. 4,413,110. These fibers were shown to have a high tenacity, greater than 30 or even 40 gram/denier and a high tensile modulus greater than 1000 or even 1600 or 2000 gram/denier.

U.S. Pat. Nos. 4,737,402 and 4,613,535 disclose complex rigid composite articles having improved impact resistance which comprise a network of high strength fibers such as ultra-high molecular weight polyethylene and polypropylene embedded in an elastomeric matrix material and at least one additional rigid layer on a major surface of the fibers in the matrix. It is disclosed that the composites have improved resistance to environmental hazards, improved impact resistance and are unexpectedly effective as ballistic resistant articles such as armor.

U.S. Pat. No. 4,836,084 discloses an armor plate composite composed of four main components, a ceramic impact layer for blunting the tip of a projectile, a sub-layer laminate of metal sheets alternating with materials impregnated with a viscoelastic synthetic material for absorbing the kinetic energy of the projectile by plastic deformation and a backing layer consisting of a pack of impregnated materials. It is disclosed that the optimum combination of the four main components gives a high degree of protection at a limited weight per unit of surface area.

U.S. Pat. No. 4,681,792 discloses an improved, flexible article comprising a plurality of first flexible layers, each of said first layers consisting essentially of fibers having a tensile modulus of at least about 300 gram/denier and a tenacity of at least about 15 gram/denier and a plurality of second flexible layers, each of said second flexible layers comprising fibers with a resistance-to-displacement being greater than the resistance-to-displacement of fibers in the first flexible layers.

U.S. Pat. No. 5,480,706 discloses a fire resistant ballistic resistant multilayer complex comprising one or more first layers comprising a network of flammable polymeric fibers in a matrix and one or more second layers comprising a network of fire resistant organic or inorganic fibers in a matrix. The different layers are distributed through the fire resistance multilayer complex ballistic resistant article in an alternating fashion.

U.S. Pat. No. 6,119,575 discloses a composite for body armor containing at least one ply comprising aromatic polymer fibers in a first polymeric matrix, at least one ply comprising polyolefin fibers in a second polymeric matrix, and at least one ply of a woven plastic positioned between the other two polymeric plies. The plies are disclosed to be crossplied in a 0°/90°/0°/90° orientation.

U.S. Pat. No. 6,183,834 discloses a ballistic-resistant molded article containing a compressed stack of monolayers, with each monolayer containing unidirectionally oriented reinforcing fibers and at most 30 wt. % of a plastic matrix material with the fiber direction in each monolayer being rotated with respect to the fiber direction in an adjacent monolayer, the compressed stack having at least 98% of the at least theoretically maximum density.

U.S. Pat. No. 6,238,768 discloses antiballistic shaped part comprising a stack of composite layers, wherein each composite layer comprises two or more monolayers of unidirectionally oriented fibers in a matrix, the fibers in each monolayer being at an angle to the fibers in an adjoining monolayer and the composite layer containing at most 10% by weight of an elastomeric matrix material calculated on the basis of the total weight of the composite layer.

There is an unmet need for antiballistic articles with improved properties compared to those known in the art, particularly to provide materials that are lighter and more resistant having higher tenacity, tensile modulus and energy-to-break. The present invention now meets this need.

### SUMMARY OF THE INVENTION

The present invention provides a ballistic resistant composite material comprising at least two distinct types of polymer fibers. In particular, the combination of at least two distinct types of ballistic resistant polymer fibers in the ballistic resistant composite material of the present invention, having improved properties compared to composite materials comprising each type of polymer fiber alone.

The invention also relates to a method for manufacturing ballistic resistant composite materials comprising at least two distinct types of polymer fibers.

According to a first embodiment, the present invention provides a ballistic resistant composite material comprising a plurality of monolayers, wherein at least one such monolayer comprises a first type of polymer fiber and at least one other such monolayer comprises a second type of polymer fiber distinct from the first type.

According to another embodiment, the present invention provides a ballistic resistant composite material comprising a plurality of monolayers wherein at least one such monolayer comprises at least two distinct types of polymer fibers. In this alternative embodiment, the two distinct types of polymer fibers can advantageously be arrayed in an alternating or substantially alternating fashion.

For these embodiments, the polymer fibers in each monolayer are arrayed in a substantially unidirectional orientation, preferably adjacent monolayers are aligned at an angle to one another and adjacent monolayers are bonded together by an elastomeric matrix.

The preferred fibers for these embodiments are selected from the group consisting of aramid, polyethylene and poly-(p-phenylenebenzobisoxazole) particularly, poly-(1,4-phenylene-2,6-benzobisoxazole) (PBO). The more preferred ballistic resistant composite material comprises poly-(p-phenylenebenzobisoxazole) fibers together with at least one additional type of ballistic resistant polymer fiber. The additional type of ballistic resistant polymer fiber is advantgeously selected from aramid and polyethylene fibers.

According to certain preferred embodiments, the present invention provides a ballistic resistant composite material which comprises poly-(1,4-phenylene-2,6-benzobisoxazole) (PBO) fibers together with aramid fibers, wherein in one embodiment PBO comprises about 20% to 80% of the composite material. In another embodiment PBO comprises about 60% to 80% of the composite material. In yet another embodiment PBO comprises about 40% to 60% of the composite material. In yet another embodiment PBO comprises about 20% to 40% of the composite material.

According to yet another certain embodiment the present invention provides a ballistic resistant composite material which comprises both aramid and polyethylene fibers.

According to another embodiment the present invention provides a method for preparing a ballistic resistant composite material comprising a plurality of monolayers wherein at least one such monolayer comprises at least two distinct types of polymer fibers.

### BRIEF DESCRIPTION OF THE DRAWINGS

The invention will be more fully understood and further advantages will become apparent when reference is made to the following detailed description of the invention and the accompanying drawings in which:

FIG. 1 is a schematic cross-sectional view of a ballistic resistant composite material according to the present invention, comprising two distinct monolayers (10 and 12) bonded to each other by an elastomeric matrix (14), the fibers in one monolayer aligned in a 90° orientation with respect to the fibers in the other monolayer.

FIGS. 2A-B are a schematic cross-sectional view (A) and top view (B), respectively of a ballistic resistant composite material according to the present invention, comprising four monolayers of unidirectional fibers in an interstitial resin (14), wherein the two internal monolayers are the same (10) and the two external monolayers are the same (12), and the four monolayers, bonded to each other by an elastomeric matrix, are aligned in 0°/90°/0°/90° orientation.

FIG. 2C is a photographic view of a “MEGAFLEX” ballistic resistant material according to the present invention, wherein the two internal monolayers comprise unidirectional poly-(1,4-phenylene-2,6-benzobisoxazole) (PBO) fibers (ZYLON®) (20) and the two external monolayers comprise unidirectional aramid fibers (TWARON® 2000) (22).

FIGS. 3A-D are a schematic-cross sectional view (A, C) and top view (B, D), respectively, of a ballistic resistant monolayer of unidirectional fibers, comprising two distinct types of fibers (30 and 32) in an interstitial resin (34), denoted hereinafter “ZEBRAFLEX” (A-B) and “ZEBRA-LIGHT” (C-D).

FIG. 4A is a schematic cross-sectional view of a ballistic resistant composite material according to the present invention formed of two ZEBRAFLEX monolayers, aligned in a 90° orientation with respect to each other.

FIG. 4B is a photographic view of a ZEBRAFLEX ballistic resistant composite material formed of two ZEBRAFLEX monolayers, each layer comprises about 50% PBO (20) and about 50% aramid (22) fibers.

FIG. 5 is a photographic view of a ZEBRA-LIGHT ballistic resistant composite material formed of two ZEBRA-LIGHT monolayers, each layer comprises about 32% PBO (20) and about 68% aramid (22) fibers.

FIGS. 6A-B are a schematic cross-sectional view (A) and top view (B), respectively, of a ballistic resistant composite material, formed of four ZEBRA monolayers of unidirectional fibers in an interstitial resin (34), each layer comprises about 50% PBO (20) and 50% aramid (22) fibers, bonded to each other by an elastomeric matrix and aligned in 0°/90°/0°/90° orientation.

### DETAILED DESCRIPTION OF THE PREFERRED EMBODIMENTS

It is now disclosed for the first time that a ballistic resistant composite material of the present invention which comprises poly-(p-phenylenebenzobisoxazole) fibers, preferably poly-(1,4-phenylene-2,6-benzobisoxazole) (PBO) fibers, together with at least one additional distinct type of ballistic resistant polymer fiber are advantageously less sensitive to heat and less sensitive to humidity and therefore more stable as compared to materials which contain PBO fibers alone.

Another major advantage to the use of composite materials comprising PBO together with at least one additional type of fiber is the high cost of the PBO, which may be prohibitively expensive on its own.

It is further disclosed that a ballistic resistant composite material of the present invention which comprises PBO fibers together with a second distinct type of polymer selected from aramid fibers or ultra high molecular weight polyethylene fibers is both unexpectedly less sensitive to heat and less sensitive to humidity and therefore more stable as compared to materials which contain PBO fibers alone, and further exhibits better ballistic resistance than materials which contain either aramid fibers or ultra high molecular weight polyethylene fibers alone.

It has been discovered that use of the ballistic resistant material of the present invention for manufacturing ballistic resistant articles, particularly articles of clothing provides unexpectedly comfortable, flexible and low weight antiballistic fabrics since only a small number of composite layers are required to obtain effective ballistic resistance.

The ballistic resistant armor of the present invention exhibits several unique advantages, due to the fact that the combination of two or more distinct types of polymer fiber provides armor with advantages of both types of fiber and overcomes the disadvantages of each of the individual types of fiber.

(i) Definitions

The term “fiber” comprises not only a monofilament but, inter alia, also a multifilament yarn or flat tapes. The term unidirectionally oriented fibers refers to fibers which, in one plane, are essentially oriented in parallel.

The term “monolayer”, which may also be referred to as a “composite monolayer” or “composite layer”, as used herein refers to a layer of unidirectionally oriented fibers embedded in an interstitial resin matrix, preferably, in the form of continuous multifilament bundles of fibers, also denoted herein “yarns”, oriented substantially in parallel in a plane. Before or after being oriented in parallel in the plane, the fibers are coated with an amount of a liquid comprising an interstitial resin matrix material or a precursor which, in a later stage in the manufacture of the monolayer, reacts to give the interstitial resin matrix material having the required modulus of elasticity.

The term “elastomeric matrix” refers to a material which binds the fibers together within a monolayer or between adjacent monolayers. In addition to the elastomeric material the matrix may, if desired, contain the usual fillers or other substances. The matrix is generally homogeneously distributed over the entire surface of the monolayer. The liquid matrix may be a solution, dispersion or a melt.

The term “interstitial resin”, which is also referred to interchangeably by the term elastomeric matrix, refers to a material which binds the fibers together within a monolayer. The interstitial resin, or matrix, within a monolayer generally encloses the fibers in their entirety or in part. In addition to an elastomeric material the interstitial resin may, if desired, contain the usual fillers or other substances. The interstitial resin is generally homogeneously distributed over the entire surface of the monolayer. The liquid resin may be a solution, a dispersion or a melt.

The term “precursor” refers to a monomer, an oligomer or a cross-linkable polymer.

The term “composite material”, as used herein, denotes an article or a fabric composed of two or more monolayers of polymer fibers. Preferably, the fibers in each monolayer are unidirectionally oriented and are embedded in an interstitial resin matrix, the fibers in each monolayer being at an angle to the fibers in an adjoining underlying monolayer. Adjacent monolayers are bonded together by an elastomeric matrix material, or otherwise laminated together. The interstitial resin or the elastomeric matrix in adjoining layers may be the same or different, and each of these matrices may include varying proportions of additional materials such as fillers, lubricants or the like as are well known in the art. The angle, which means the smallest angle enclosed by the fibers of the adjoining monolayers, is between 0° and 90°. In a particularly preferred alignment, the angle is between 80° and 100°. A ballistic resistant material in which the fibers in the adjoining monolayers are at such an angle to one another have better antiballistic characteristics.

As used herein the term “ballistic resistant fiber” refers to a polymeric fiber having the following attributes: a tenacity of about 10 gram/denier, preferably about 15 gram/denier, more preferably about 20 gram/denier, most preferably about 25 gram/denier; tensile modulus of about 150 gram/denier, preferably about 500 grams/denier, more preferably about 1000 grams/denier, most preferably from about 1000 grams/denier to about 2500 gram/denier; and an energy-to-break of about 8 Joules/gram preferably of about 30 Joules/gram, more preferably about 35 Joules/gram and most preferably about 40 Joules/gram.

The term “denier” is a weight-per-unit-length measure of any linear material particularly for filament yams. It is the number of unit weight of 0.05 grams per 450 meter length. Which is numerically equal to weight in grams of 9,000 meters of the material. In most countries outside the U.S. the denier system has been replaced by the Tex system wherein 1 denier equals 1.1111 dTex.

“V50” is a measure of the strength-to-weight ratio of a ballistic resistant material as it relates to stopping bullets or bomb fragments. The V50 value refers to the velocity (V) at which a bullet will have a 50 percent chance (50) of penetrating a given piece of armor. The numerical V50 value is the average value obtained by shooting the armor repetitively, with the same type of bullet, across a range of velocities.

(ii) Preferred Modes for Carrying out the Invention

The present invention provides a ballistic resistant material made from at least two distinct types of polymeric fibers. The ballistic resistant composite material comprises a plurality of monolayers laminated or bonded together by an elastomeric matrix.

Each monolayer comprises one or more type of unidirectionally oriented fibers embedded in an interstitial resin matrix. The fibers in each monolayer, preferably in the form of continuous multifilament bundles of fibers, or yams are oriented in parallel in a plane, by methods known in the art. For examples, the yams are guided from a bobbin frame across a comb, as a result of which they are oriented in parallel in a plane. Before or after being oriented in parallel in the plane, the fibers are coated with an amount of a liquid comprising the interstitial resin matrix or a precursor thereof.

Preferably fibers are in the form of continuous multifilament yams. Preferably the fibers in each monolayer are oriented at an angle to the fibers in an adjoining monolayer. The invention also relates to a method for producing said ballistic resistant composite material.

The degree to which the distinct types of monolayers or distinct types of fiber within a monolayer of the present invention alternate may vary widely depending on a number of factors such as the number and thickness of these monolayers, the desired level of ballistic resistance and the like. In certain preferred embodiments, the alternation is such that each first monolayer is adjacent to at least a second monolayer having the same composition. More preferably these two adjacent monolayers have unidirectional fibers at an orthogonal angle of approximately 80°-90°, or 90° to 100°, to one another.

The total weight of the preferred composite monolayer is between about 20 g/m² to about 250 g/m². The total weight of the preferred antiballistic composite material will depend on the number of monolayers used therein to obtain the required resistance to projectiles. The skilled artisan can best determine the optimal size and weight of the composites for any particular fiber combination, with preferred combinations being disclosed herein. It was found that, surprisingly, as a result of the combination of at least two distinct polymer fibers, preferably selected from PBO, aramid and polyethylene, it is possible to produce ballistic resistant composite materials having improved properties compared to known ballistic resistant articles.

It was found that, surprisingly, as a result of the combination of poly (p-phenylenebenzobisoxazole) fibers together with at least one additional distinct type of polymeric fiber it is possible to produce ballistic resistant composite materials having improved properties compared to known ballistic resistant articles.

According to a currently most preferred embodiment of the present invention poly-(1,4-phenylene-2,6-benzobisoxazole) (PBO), in combination with at least one polymer selected from aramid or ultra high molecular weight polyethylene fibers, provides a very high energy absorption in the event of a hit by a projectile, low sensitivity to humidity and heat and a very high flexibility in the antiballistic material obtained.

With a view to obtaining high energy absorption, the relative content of poly-(p-phenylenebenzobisoxazole) fibers in the ballistic resistant composite material of the invention is chosen to be between 10% to 90%. Preferably, the content of poly-(p-phenylenebenzobisoxazole) fibers in the ballistic resistant composite material according to the invention is about 20% to 80% by weight and more preferably about 20% to about 60% by weight.

An additional consideration is that the PBO fiber is more costly than the additional distinct type of fiber used in the composite material of the invention It is now shown that with a ballistic resistant composite material of the invention, the effective ballistic resistance is significantly improved as compared with antiballistic composite materials known in the art. Particularly, it is possible to generate an effective low-weight ballistic resistant material of the invention, which is light and flexible containing only a small number of monolayers. This makes the ballistic resistant composite material of the invention particularly suitable for applications where high flexibility is desirable, such as in fabrics made for protective clothing including body armor.

a. Fibers for Production of Antiballistic Materials

Preferred fibers for use in the practice of this invention are those having a tenacity equal to or greater than about 10 grams/denier, a tensile modulus equal to or greater than about 150 grams/denier, and an elongation-at-break equal to or smaller than about 4.5%. Particularly preferred fibers are those having a tenacity equal to or greater than about 20 grams/denier, a tensile modulus equal to or greater than about 500 grams/denier and elongation-at-break equal to or smaller than about 3.9%. Amongst these particularly preferred embodiments, currently preferred are those embodiments in which the tenacity of the fibers are equal to or greater than about 25 grams/denier, a tensile modulus equal to or greater than about 800 gram/denier and elongation-at-break is equal to or smaller than about 3%. In the practice of this invention, fibers of choice have a tenacity equal to or greater than about 35 grams/denier, a tensile modulus equal to or greater than about 1000 grams/denier, and the elongation-at-break is equal to or smaller than about 2%.

All tensile properties are evaluated by methods known in the art, for example, by pulling a 10 in. (25.4 cm) fiber length clamped in barrel clamps at a rate of 10 inch/min (25.4 cm/min) on an Instron Tensile Tester.

In currently preferred embodiments of the invention, each monolayer comprises at least one type of relatively high molecular weight fibers, selected from the group of: liquid Iyotropic crystalline polymers with heterocyclic units such as poly-(1,4-phenylene-2,6-benzobisthiazole) (PBT), poly-(1,4-phenylene-2,6-benzobisoxazole) (PBO; ZYLON®), poly-(1,4-phenylene-1,3,4-oxadiazole), poly-(1,4-phenylene-2,6-benzobisimidazole), poly[2,5(6)-benzimidazole] (AB-PBI), poly[2,6-(1,4-phneylene)-4-phenylquinoline], poly[1,1′-(4,4′-biphenylene)-6,6′-bis(4-phenylquinoline)] and the like; aramids (aromatic polyamides), such as poly (metaphenylene isophthalamide; NOMEX®) and poly (p-phenylene terephthalamide; KEVLAR®) and the like; ultra high molecular weight polyethylene fibers (e.g. DYNEEMA®).

U.S. Pat. No. 4,457,985 generally discusses high molecular weight polyethylene and polypropylene fibers. Extended chain polyethylene (ECPE) fibers may be grown in solution as described in U.S. Pat. Nos. 4,137,394 and 4,356,138 or fiber spun from a solution to form a gel structure, as described in U.S. Pat. No. 4,344,908, and especially described in U.S. Pat. No. 4,551,296.

In currently preferred embodiments of this invention, useful fibers for use in the production of the composite layers are poly-(1,4-phenylene-2,6-benzobisoxazole) (PBO) fibers, aramid fibers and ultra high molecular weight polyethylene fibers.

In currently preferred embodiments of this invention, each monolayer is composed of two or more types of continuous fibers embedded in a continuous phase of an interstitial resin material which preferably substantially coats each fiber contained in the bundle of fibers.

Monolayers of fibers can have various configurations. For example, a plurality of fibers can be grouped together to form a twisted or untwisted yam in various alignments. The fibers or yarn may be formed as a felt, knitted or woven (plain, basket, and crow feet weaves, etc.) into a monolayer. The fibers may be aligned in a substantially parallel, unidirectional fashion, or fibers may be aligned in a multidirectional fashion, or with fibers at varying angles with each other or formed into a monolayer by any of a variety of conventional techniques. In the preferred embodiments of the invention, the fibers are untwisted mono-fiber yam wherein the fibers are parallel, unidirectionally aligned.

In one currently preferred embodiment of the present invention, the ballistic resistant composite material of the invention, also denoted hereinafter “MEGAFLEX”, comprises at least two distinct types of monolayers, which are arrayed in parallel to one another, wherein at least one first monolayer comprising poly-(p-phenylenebenzobisoxazole) fibers in an interstitial resin matrix is adjoined to at least one second monolayer comprising polymer fibers selected from aramid or ultra high molecular weight polyethylene (uhmwPE) fibers in a matrix. Said first and second types monolayers may be distributed through said composite material in an alternating or substantially alternating fashion, or in any other sequence that is desired. In particularly preferred embodiments the monolayers are arranged as aramid-PBO-PBO-aramid or uhmwPE-PBO-PBO-uhmwPE.

The unidirectional fibers in each monolayer are at an angle to the fibers in an adjoining underlying monolayer, wherein the smallest angle enclosed by fibers of successive adjoining monolayers is between 0° and 90. Most preferably, the angle is between 80° and 90° or between 90° and 100°.

In another currently preferred embodiment of the present invention, the ballistic resistant material of the invention, also denoted hereinafter “ZEBRAFLEX”, comprises at least two monolayers each monolayer comprising at least two distinct types of polymer fibers, which are arranged in a stripe-like array such that at least one first polymer fiber of poly-(p-phenylenebenzobisoxazole) unidirectional fibers in an interstitial resin matrix is aligned parallel next to a second polymeric fiber selected from aramid or ultra high molecular weight polyethylene fibers in an interstitial resin matrix along a common fiber direction in a common plane, wherein said first and second fibers are distributed through said monolayer in an alternating or substantially alternating fashion.

b. Resin and Matrix Materials

The types of interstitial resin and matrix materials may vary widely, and usually depend on the type of material used to form the fibers. For example, in those instances where the fibers are formed from polymeric materials, a polymeric material such as a thermosetting or thermoplastic resin or a combination thereof is generally used. On the other hand, in those instances where the fibers are formed from a ceramic material, the resin and matrix materials can be a polymeric material and in addition can be a metallic material.

Illustrative of use for resin and matrix materials are thermoplastic polymers such as polyetherimides, polyestercarbonates, polyesters, polyamides, polyethersulfones, polyurethanes, polyolefins, polydienes, polydiene olefins, polycarbonates, polyimides, polyphenyleneoxides, polyurethane elastomers, polyesterimides, poly-(imide amides), polylactones, polyether ketones, polyestercarbonates, polyphenylene sulfides, polyether ether ketones, and the like; thermosetting resins such as epoxy resins, phenolic resins, vinyl ester resins, modified phenolic resins, unsaturated polyester, allylic resins, alkyd resins, urethanes and melamine urea resins and the like; polymer alloys and blends of thermoplastic and/or thermosetting resins; and interpenetrating polymer networks such as those of polycyanatopolyol such as dicyanoester bisphenol A and a thermoplastic resin such as a polysulfone. Suitable matrix materials also include metals such as nickel, manganese, tungsten, magnesium, titanium, aluminum and steel and alloys such as manganese alloys, nickel alloys, and aluminum alloys. In the preferred embodiments of the invention, the fibers are formed of a polymeric material and the resin and the matrix material is a polymer.

One preferred polymeric material for use in the manufacture of monolayers according to the principles of the present invention is a mixture or blend of one or more thermosetting resins such as a vinyl ester resin and one or more thermoplastic resins such as a thermoplastic polyurethane.

Another preferred polymeric material for use in the manufacture of monolayers according to the principles of the present invention is a low modulus elastomeric material. A wide variety of elastomeric materials and formulation may be utilized in the preferred embodiments of this invention. Representative examples of suitable elastomeric materials for use in the formation of the matrix are those which have their structures, properties, and formulation together with cross-linking procedures summarized in the Encyclopedia of Polymer Science, Volume 5 in the section Elastomers-Synthetic (John Wiley & Sons Inc., 1964). For example, any of the following elastomeric materials may be employed: polybutadiene, polyisoprene, natural rubber, ethylene-propylene copolymers, ethylene-propylene-diene terpolymers, polysulfide polymers, polyurethane elastomers, chlorosulfonated polyethylene, polychloroprene, plasticized polyvinylchloride using dioctyl phthate or other plasticizers well known in the art, butadiene acrylonitrile elastomers, poly-(isobutylene-co-isoprene), polyacrylates, polyesters, unsaturated polyesters, vinyl esters, polyethers, fluoroelastomers, silicone elastomers, thermoplastic elastomers, and copolymers of ethylene.

Particularly useful elastomers are polysulfide polymers, polyurethane elastomers, unsaturated polyesters vinyl esters; and block copolymers of conjugated dienes such as butadiene and isoprene are vinyl aromatic monomers such as styrene, vinyl toluene and t-butyl styrene are preferred conjugated aromatic monomers. Block copolymers incorporating polyisoprene may be hydrogenated to produce thermoplastic elastomers having saturated hydrocarbon elastomer segments. The polymers may be simple triblock copolymers of the type A-B-A, multiblock copolymers of the type (AB)n (n=2-10) or radial configuration copolymers of the type R-(BA)x (x=3-150); wherein A is a block from a polyvinyl aromatic monomer and B is a block from a conjugated dien elastomer. Many of these polymers are produced commercially by the Shell Chemical Co. and described in the bulletin “KRATON® Thermoplastic Rubber” SC-68-81.

The interstitial resin and the elastomeric matrix material consists essentially of at least one of the above-mentioned elastomers. The low modulus elastomeric matrices may also include fillers such as carbon black, glass microballoons, and the like up to an amount preferably not to exceed about 250% by volume of the elastomeric material, more preferably not to exceed about 100% by volume and most preferably not to exceed about 50% by volume. The matrix material may be extended with oils, may include fire retardants such as halogenated paraffins, and vulcanized by sulfur, peroxide, metal oxide, or radiation cure systems using methods well known to rubber technologists. Blends of different elastomeric materials may be blended with one or more thermoplastics. High density, low density, and linear low density polyethylene may be cross-linked to obtain a matrix material of appropriate properties, either alone or as blends. In every instance, the modulus of the elastomeric matrix material should not exceed about 6,000 psi (41,300 kPa), preferably is less than about 5,000 psi (34,500 kPa), more preferably is less than 500 psi (3450 kPa).

In certain preferred embodiments of the invention, the same material is used for interstitial resin and for elastomeric matrix. The preferred material is an elastomeric material which is a water base dispersion of Kraton®D1107 rubber (Shell Chemical Co.) The proportions of matrix to fiber in the ballistic resistant composite material of the invention, particularly in the monolayers forming the composite materials, may vary widely depending on a number of factors including, whether the matrix material has any ballistic-resistant properties of its own (which is generally not the case) and upon the rigidity, shape, heat resistance, wear resistance, fire resistance and other properties desired for monolayers. In general, the proportion of matrix to fiber in the monolayers may vary from relatively small amounts where the amount of matrix is about 10% by volume of the fibers to relatively large amount where the amount of matrix is up to about 90% by volume of the fibers.

In the preferred embodiments of this invention, the elastomeric material in the matrix amounts to from about 5% to about 25% by weight of the total weight of the composite material are employed. All weight percents are based on the total weight of the monolayers. In the particularly preferred embodiments of the invention, the monolayers in the ballistic-resistant material of the present invention, contain a relatively minor proportion of the matrix (e.g., about 8% to about 17% by weight of monolayer), since the ballistic-resistant properties are almost entirely attributable to the fibers and may be reduced by the matrix material as disclosed in “The Effect of Resin Concentration and Laminating Pressures on KEVLAR® Material Bonded with Modified Phenolic Resin” (Lastnik, et al., Tech. Report NATICK/TR-84/030, 1984).

c. Techniques for Preparing Composite Layers

Layers comprised of polymeric fibers in a polymeric matrix can be prepared by conventional procedures as known in the art.

In the preferred embodiments of the invention the fibers, pre-coated if desired with an interstitial resin material, are arranged into layers as described above. The coating may be applied to the fibers in a variety of ways and any method known to those of skill in the art for coating fibers may be used. For example, one method is to apply the interstitial resin material to the stretched high modulus fibers either as a liquid, a sticky solid or particles in suspension, or as fluidized bed. Alternatively, the matrix material may be applied as a solution or emulsion in a suitable solvent which does not adversely affect the properties of the fiber at the temperature of application. In these illustrative embodiments, any liquid may be used.

However, in the preferred embodiments of the invention in which the matrix material is an elastomeric material, preferred groups of solvents include water, paraffin oils, ketones, alcohols, aromatic solvents or hydrocarbon solvents or mixtures thereof, with illustrative specific solvents including paraffin oil, xylene, toluene and octane. The techniques used to dissolve or disperse the matrix in the solvents will be those conventionally used for the coating of similar elastomeric materials on a variety of substrates.

Other techniques for applying the coating to the fibers may be used, including coating during the process of fiber preparation. For example, coating of a high modulus precursor (gel fiber) before a high temperature stretching operation if desired, either before or after removal of the solvent from the fiber. The fiber may then be stretched at elevated temperatures to produce the coated fibers. The gel fiber may be passed through a solution of the appropriate matrix material, as for example an elastomeric material dissolved in paraffin oil, or an aromatic or aliphatic solvent, under conditions to attain the desired coating. Crystallization of the polymer in the gel fiber may or may not have taken place before the fiber passes into the cooling solution. Alternatively, the fiber may be extruded into a fluidized bed of the appropriate matrix material in powder form.

In each monolayer fibers are dispersed or embedded in a matrix material. Wetting and adhesion of fibers in the matrix material may be enhanced by prior treatment of the surface of the fibers. The method of surface treatment may be chemical, physical or a combination of chemical and physical actions. Examples of purely chemical treatments are use of SO₃ or chlorosulfonic acid. Examples of combined chemical and physical treatments are corona discharge treatment or plasma treatment using one of several commonly available machines.

Furthermore, if the fiber achieves its final properties only after a stretching operation or other manipulative process, e.g. solvent exchanging, drying or the like, it is contemplated that the coating may be applied as a precursor material of the final fiber. In such cases, the desired and preferred tenacity, modulus and other properties of the fiber should be judged by continuing the manipulative process on the fiber precursor in a manner corresponding to that employed on the coated fiber precursor. Thus, for example, if the coating is applied to the xerogel fiber described in U.S. Pat. No. 4,551,296 and the coated xerogel fiber is then stretched under defined temperature and stretch ratio conditions, then the fiber tenacity and fiber modulus values would be measured on uncoated xerogel fiber which is similarly stretched.

The fibers and monolayers produced therefrom are formed into composite layers as the basis to preparing the ballistic resistant material of the present invention.

The proportion of elastomeric matrix (comprising the elastomeric material and in addition may, if desired, contain the usual fillers for polymers or other substances additives) to fiber is variable for the composite layer, with matrix material amounts of from about 5% to about 90 vol %, by volume of the composite layer, representing the broad general range. Within this range, it is preferred to use composite layers having a relatively high fiber content, such as composite layer having only about 5 to about 50 vol % matrix material, by volume of the layer. More preferably from about 7 to about 30 vol % matrix material by volume of the layer, is used.

Stated another way, the fibers occupy different proportions of the total volume of the monolayer. Preferably, however, the fibers comprise about 10 volume percent of the composite layer. For ballistic protecting, the fibers comprise about 50 volume percent, more preferably about 70 volume percent, and most preferably about 90 volume percent, with the matrix occupying the remaining volume.

A particularly effective technique for preparing a preferred monolayer of this invention comprised of substantially parallel, undirectionally aligned fibers includes the steps of pulling a fiber or bundles of fibers through a bath containing a solution of a matrix material preferably, an elastomeric matrix material, and circumferentially winding this fiber into a single sheet-like layer around and along a bundle of fibers the length of a suitable form, such as a cylinder. The solvent is then evaporated leaving a sheet-like layer of fibers embedded in a matrix that can be removed from the cylindrical form. Alternatively, a plurality of fibers or bundles of fibers can be simultaneously pulled through the bath containing a solution or dispersion of a matrix material and laid down in closely positioned, substantially parallel relation to one another on a suitable surface. Evaporation of the solvent leaves a sheet-like layer comprised of fibers which are coated with the matrix material and which are substantially parallel and aligned along a common fiber direction. The sheet is suitable for subsequent processing such as laminating to another sheet to form composites containing more than one layer.

Similarly, a yarn-type simple composite can be produced by pulling a group of fiber bundles through a dispersion or solution of the matrix material to substantially coat each of the individual fibers, and then evaporating the solvent to form the coated yarn. The yarn can then, for example, be employed to form fabrics, which in turn, can be used to form more complex composite structures. Moreover, the coated yarn can also be processed into a simple composite by employing conventional fiber winding techniques; for example, the simple composite can have coated yarn formed into overlapping fiber layers.

### EXAMPLES

The following examples are presented to provide a more complete understanding of the invention. The specific techniques, conditions, materials, proportions and reported data set forth to illustrate the principles of the invention are exemplary and should not be construed as limiting the scope of the invention.

### EXAMPLE I

### Preparation of Aramid Monolayers

A monolayer was produced by non-twisted TWARON®2000 yarns (Teijin Twaron B. V., Arnhem, the Netherlands) having a linear density of 830 dTex to 1700 dTex, a breaking strength of 190N to 410N, an elongation-at-break of 3.45% to 3.5% and chord modulus of 79 GPa to 102 GPa. The yarns were guided from a bobbin frame over a comb, with a density of 2 to 6 yams/cm, and wetted with an interstitial resin comprising KRATON® D1107 water based dispersion (Shell Chemical Co.) based on a triblock copolymer of the polystyrene-polyisoprene-polystyrene. The final weight of each aramid monolayer was approximately 55±10 g/m².

### EXAMPLE II

### Preparation of a PBO Monolayers

A monolayer was produced by non-twisted ZYLON® yarns (Toyobo, Japan) having a linear density of approximately 1100 dTex, a tensile strength of approximately 36 cN/dTex, elongation at break of approximately 3% and modulus of approximately 1180 cN/dTex. The yarns were guided from a bobbin frame over a comb, with a density of 2 to 6 yams/cm, and wetted with an interstitial resin comprising KRATON® D1107 water based dispersion based on a triblock copolymer of the polystyrene-polyisoprenepolystyrene. The final weight of each PBO monolayer was approximately 55±10 g/m².

### EXAMPLE III

### Preparation of a Polyethylene Monolayer

A monolayer was produced by non-twisted DYNEEMA yams (DSM N.V., the Netherlands) having a linear density of 1690 dTex to 1800 dTex and a modulus of approximately 1200 cN/dTex. The yarns were guided from a bobbin frame over a comb, with a density of 2 to 6 yams/cm, and wetted with an interstitial resin comprising KRATON® D1107 water based dispersion based on a triblock copolymer of the polystyrene-polyisoprene-polystyrene. The final weight of each polyethylene monolayer was approximately 55±10 g/m².

### EXAMPLE IV

### Preparation of PBO+Aramid MEGAFLEX Composite Material

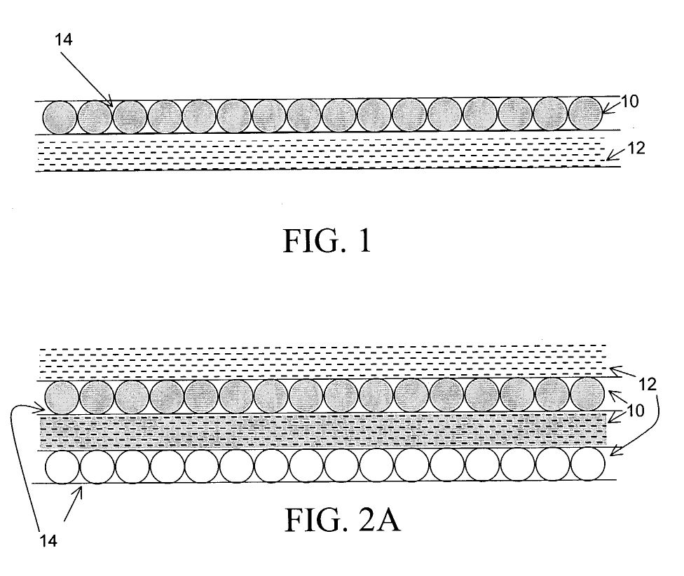

A general scheme of an antiballistic material comprising two distinct monolayers is shown in FIG. 1. Such composite material was manufactured by bonding a monolayer of unidirectional PBO fibers to a monolayer of aramid or polyethylene fibers by an elastomeric matrix. The fibers in each monolayer were at an angle of approximately 90° C. to the fibers in the adjoining monolayer.

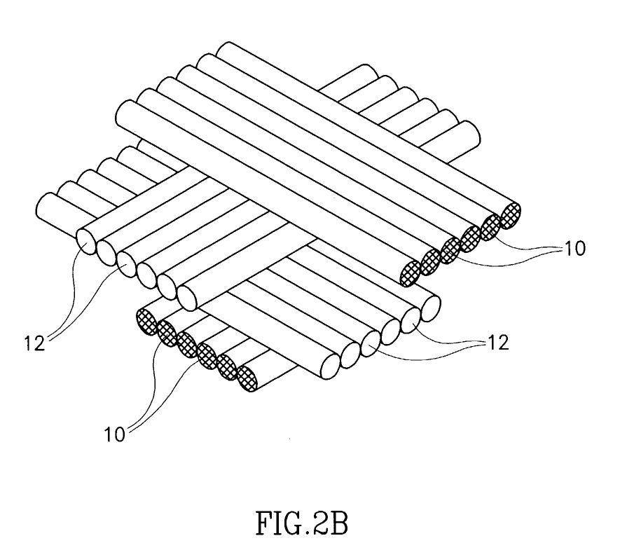

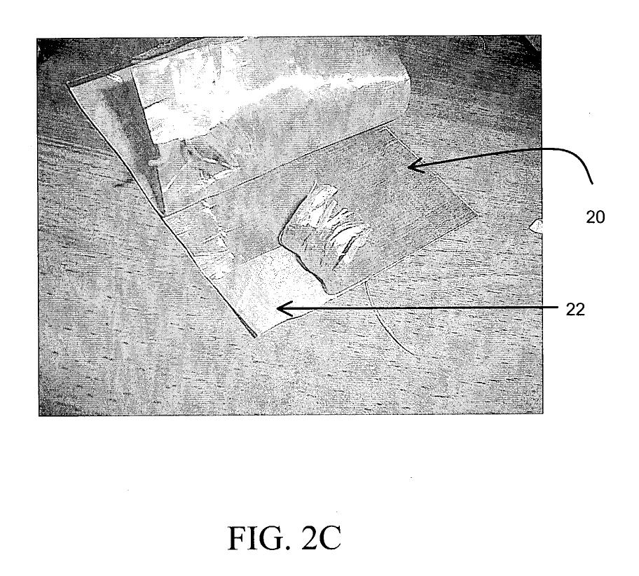

A representative MEGAFLEX antiballistic material comprising four monolayers is shown in FIGS. 2A-C. The monolayers of PBO (FIGS. 2C, 20) and aramid (FIGS. 2C, 22) fibers were arranged such that the two internal ones were from PBO monolayers and the external ones were aramid monolayers. The fibers in each monolayer were at an angle of approximately 90° C. to the fibers in the adjoining monolayers. The total weight of the resulting composite material was 234±10 g/m² including two linear films of low density polyethylene (6-7 μm thick) which were adjoined on both external sides of the composite material.

### EXAMPLE V

### Preparation of a PBO+Aramid ZEBRAFLEX and ZEBRA-LIGHT Monolayers

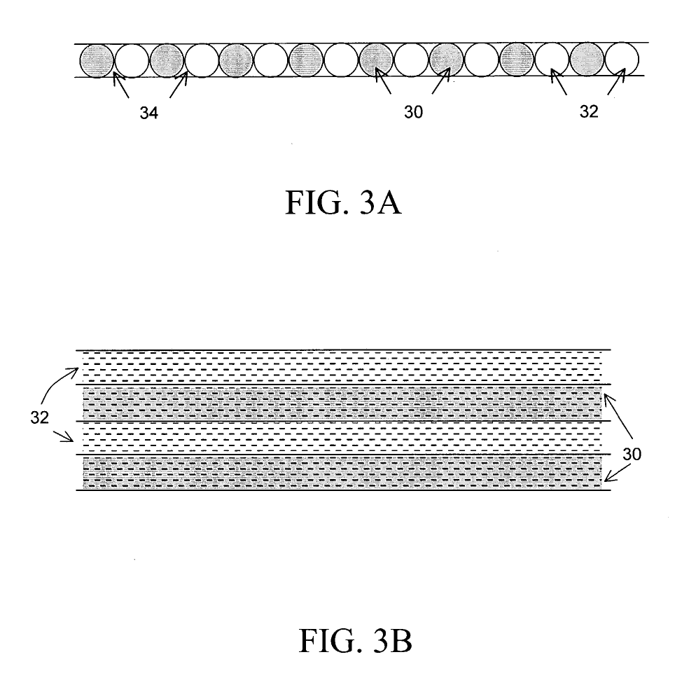

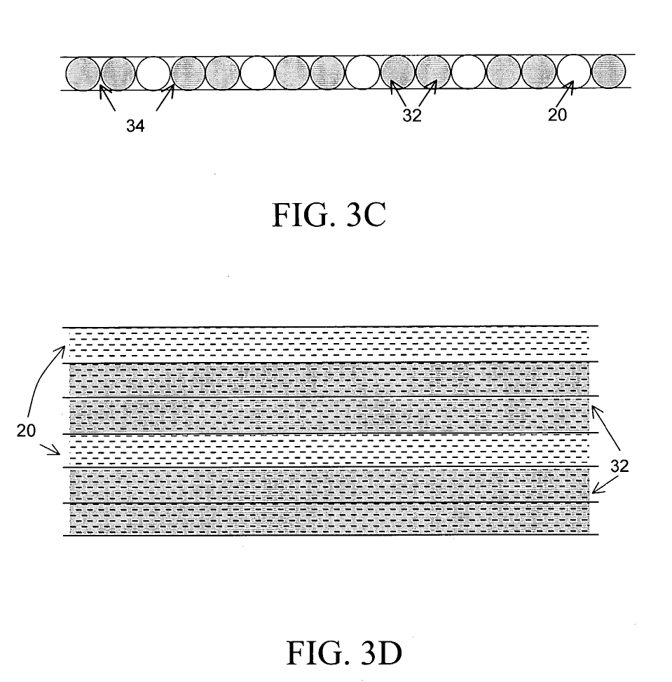

A monolayer was produced from non-twisted aramid (TWARONO®2000, Teijin Twaron B. V., Arnhem, the Netherlands) and PBO (ZYLON®, Toyobo, Japan) yarns. Bobbins of aramid and PBO yarns were arranged in a creel in a substantially alternating fashion, yarns were guided from the creel over a comb with a density of 2 to 6 yarns/cm, and wetted with an interstitial resin comprising KRATON® D1107 water based dispersion based on a triblock copolymer of the polystyrene-polyisoprenepolystyrene. For the production of ZEBRAFLEX monolayer, the aramid and PBO yarns were arranged in a creel in an alternating fashion (FIGS. 3A-B). For the production of ZEBRA-LIGHT monolayer, the aramid and PBO yarns were arranged in a creel such one every 3^{rd} creel contained PBO yarns (FIGS. 3C-D). The total weight of the resulting monolayer, ZEBRAFLEX or ZEBRA-LIGHT, was approximately 55±10 g/m².

### EXAMPLE VI

### Preparation of a Composite Material from ZEBRAFLEX and ZEBRALIGHT Monolayers

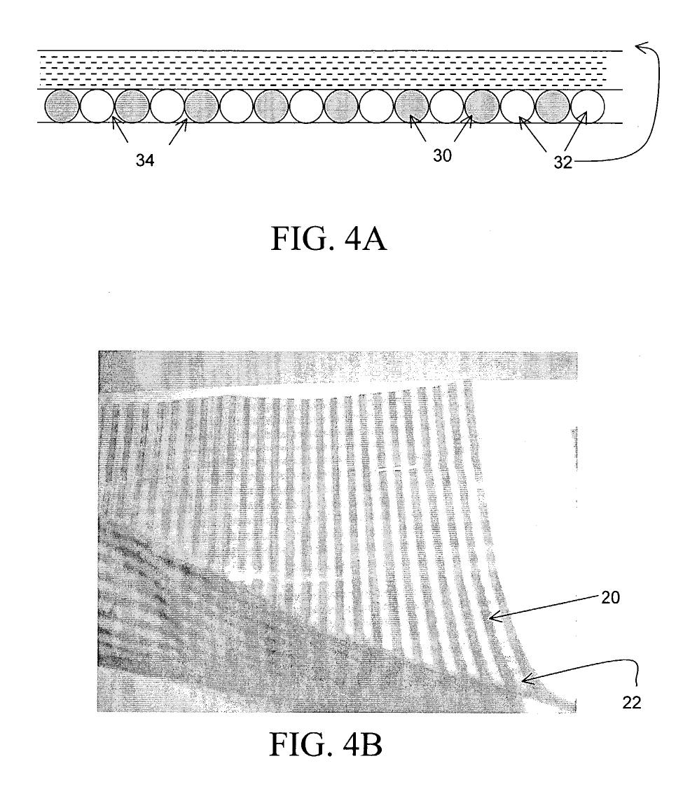

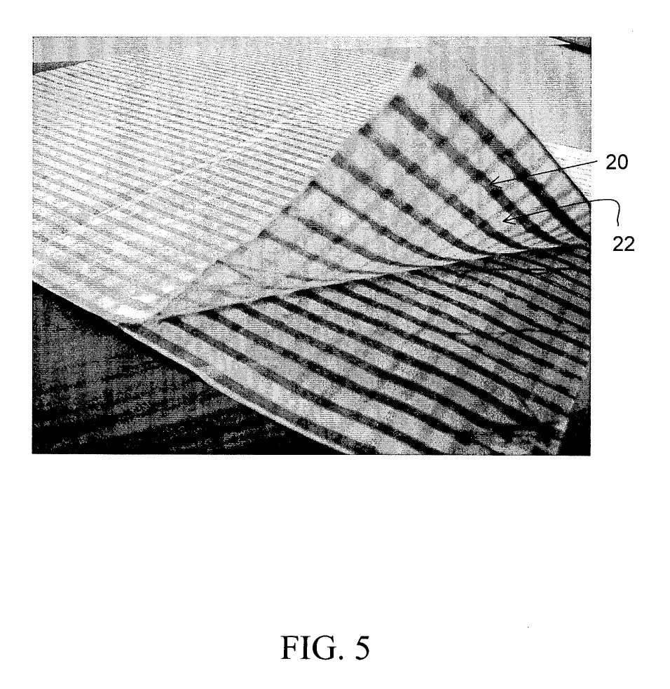

Two ZEBRAFLEX monolayers (FIGS. 3A-B) comprising PBO and aramid fibers, at an approximate ratio of 1:1, and an interstitial resin were bonded by an elastomeric matrix, which in this example was similar to the material used as the interstitial resin. The fibers in each monolayer were at an angle of approximately 90° C. to the fibers in the adjoining monolayer (FIGS. 4A-B). A composite material comprising two ZEBRALIGHT monolayers (FIGS. 3C-D) comprising PBO and aramid fibers, at an approximate ratio of 1:2, was prepared in a similar manner (FIG. 5).

The total weight of the resulting composite material, comprising ZEBRAFLEX or ZEBRA-LIGHT monolayers, was approximately 124±10 g/m² including two linear films of low density polyethylene (6-7 μm thick) which were placed over the top and under the bottom of the composite material.

The composite layer in each example contained 10% by weight of elastomeric material and 4% by weight of fillers (based on the total weight of the composite layer).

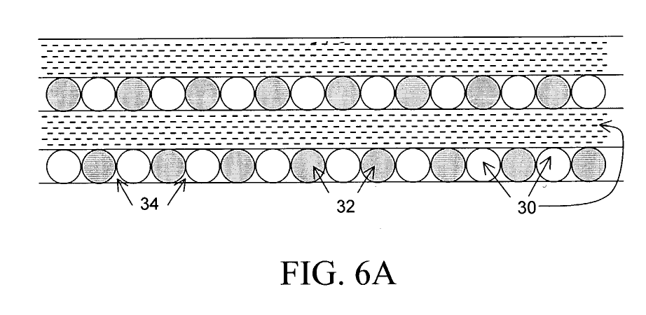

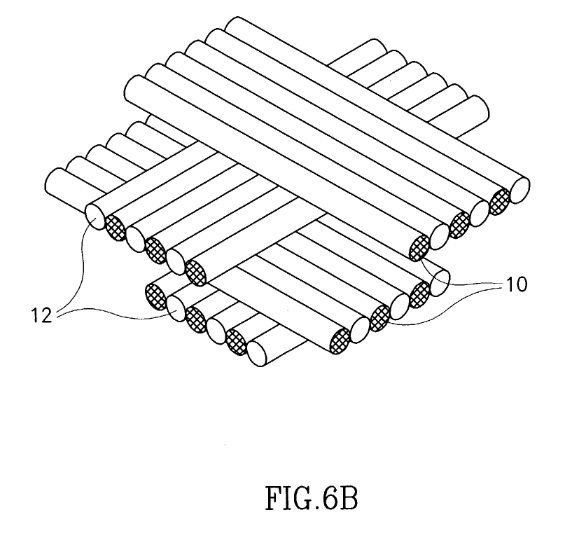

The organization of four ZEBRAFLEX monolayers in a composite material of the invention is exhibited in FIGS. 6A-B. Such composite materials weighs 234±10 g/m².

### EXAMPLE VII

### Antiballistic Performance

To evaluate the antiballistic properties of the composite materials of the invention, test samples were prepared from approximately 16 monolayers according to the principles of the invention (see Examples IV and VI) where each monolayer weighed approximately 233 gram and the total weight of the tested composite materials was from 3.187 to 3.831 kg/m².

Ballistic resistance was assessed according to military standards and common practice as known in the art using the V50 index. V50 is a measure of a ballistic material's strength-to-weight ratio as it relates to stopping bullets or bomb fragments. The V50 value refers to the velocity (V) at which a bullet will have a 50 percent chance (50) of penetrating a given piece of armor. The numerical V50 value is the average value obtained by shooting the armor numerous times, with the same type of bullet, across a broad range of velocities. There types of bullets were used in this example: Full Metal Jacket (FMJ), Semi Wet Cutter (SWC) and Just Soft Point (JSP).

Tables 1 and 2 show the results of representative ballistic testing using bullets (Table 1) and fragments (Table 2) for assessing V50 values of representative composites. The test results indicate that the ballistic performance of the composite materials of the invention exhibit similar or improved V50 values with respect to composite materials produced from only one type of polymeric fiber. Particularly, although the PBO content of MEGAFLEX, ZEBRAFLEX composites was about 50% and less than 32% in ZEBRA-LIGHT composite, these composites exhibited an antiballistic resistance which was similar to that of a composite containing 100% PBO.

TABLE 1
Antiballistic performance tested with different types of bullets.

| | | V50 (feet/sec) per bullet type | | | | |
|---|---|---|---|---|---|---|
| | | | | | 9 mm Geco | |
| | | | Mag. | Mag. | DM-41 | |
| | | | 44 | 357 | 124 grain | |
| Composite material | | 9 mm | SWC | JSP | | V50 |
| | Weight | FMJ | 240 | 158 | Weight | (feet/ |
| Type | (Kg/m²) | 124 grain | grain | grain | (kg/m²) | sec) |
| Polyethylene UD* | 3.701 | 1645 | 1512 | 1458 | 3.212 | 1629 |
| (DYNEEMA ®) | | | | | | |
| Aramid UD | 3.744 | 1590 | 1498 | 1571 | 3.268 | 1583 |
| (GOLDFLEX ™ | | | | | | |
| Aramid woven | 3.831 | 1336 | 1398 | 1404 | 3.200 | 1674 |
| PBO UD | 3.762 | 1776 | | | 3.224 | 1710 |
| (ZYLON ®) | | | | | | |
| Aramid + PBO | 3.691 | 1764 | 1610 | 1668 | 3.212 | 1684 |
| ZEBRAFLEX | | | | | | |
| Aramid + PBO | 3.681 | 1745 | 1625 | 1668 | 3.187 | 1693 |
| MEGAFLEX | | | | | | |
| Aramid + PBO | 3.648 | 1742 | 1595 | 1700 | 3.206 | 1701 |
| ZEBRA-LIGHT | | | | | | |

*UD - unidirectional

TABLE 2
Antiballistic performance tested with fragments

| Composite material | | V50 (feet/sec) |
|---|---|---|
| Type | Weight (Kg/m²) | Fragment 17 grain |
| Polyethylene (DYNEEMA ®) | 3.212 | 1629 |
| UD* | | |
| Aramid UD (GOLDFLEX ™) | 3.268 | 1583 |
| Aramid woven | 3.200 | 1674 |
| PBO UD (ZYLON ®) | 3.224 | 1710 |
| Aramid + PBO (ZEBRAFLEX) | 3.212 | 1684 |
| Aramid + PBO (MEGAFLEX) | 3.187 | 1693 |
| Aramid + PBO ZEBRA-LIGHT | 3.206 | 1701 |

*UD - unidirectional

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention. Thus the expressions “means to . . .” and “means for . . .”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A ballistic resistant composite material having a plurality of monolayers comprising unidirectionally oriented fibers in an interstitial resin matrix wherein at least one monolayer includes at least two distinct types of ballistic resistant polymeric fibers.

2. The ballistic resistant composite material of claim 1, wherein the at least two distinct types of fibers are selected from the group consisting of poly-(p-phenylene-benzobisoxazole), aramid and polyethylene fibers.

3. The ballistic resistant composite material of claim 1 wherein the at least two distinct types of fibers are arranged in substantially alternating fashion.

4. The ballistic resistant composite material according to claim 1, wherein one polymeric fiber is a poly-(p-phenylene-benzobisoxazole) fiber.

5. The ballistic resistant composite material of claim 4 wherein an additional polymeric fiber is an aramid or ultra high molecular weight polyethylene fiber.

6. The ballistic resistant composite material of claim 1 wherein one fiber is a poly-(1,4-phenylene-2,6-benzobisoxazole) (PBO) fiber.

7. The ballistic resistant composite material of claim 6 wherein an additional polymeric fiber is selected from an aramid or an ultra high molecular weight polyethylene fiber.

8. The ballistic resistant composite material of claim 6 wherein PBO comprises approximately 20-80% of the monolayer.

9. A ballistic resistant composite material comprising at least two distinct types of ballistic resistant polymer fibers, the composite material comprising a plurality of monolayers, each monolayer comprising unidirectionally oriented fibers in an interstitial resin matrix, with the fibers in each monolayer being arranged at an angle to the fibers in an adjacent monolayer, and with the monolayers being bonded together by an elastomeric material.

10. The ballistic resistant composite material of claim 9, wherein the at least two distinct fibers are selected from the group consisting of poly-(p-phenylenebenzobisoxazole), aramid and polyethylene fibers.

11. The ballistic resistant composite material according to claim 9, wherein one type of fiber is a poly-(p-phenylene-benzobisoxazole) fiber.

12. The ballistic resistant composite material of claim 9, wherein one fiber is a poly-(1,4-phenylene-2,6-benzobisoxazole) (PBO) fiber.

13. The ballistic resistant composite material of claim 11, wherein an additional polymeric fiber is an aramid or ultra high molecular weight polyethylene fiber.

14. The ballistic resistant composite material of claim 9, wherein the at least two distinct types of polymeric fibers are aramid and polyethylene fibers.

15. The ballistic resistant composite material of claim 9 wherein at least one monolayer comprises at least two distinct types of ballistic resistant polymeric fibers.

16. The ballistic resistant composite material of claim 15, wherein one fiber is a poly(p-phenylene-benzobisoxazole) fiber.

17. The ballistic resistant composite material of claim 15, wherein one fiber is a poly-(1,4-phenylene-2,6-benzobisoxazole) (PBO) fiber.

18. The ballistic resistant composite material of claim 17, wherein an additional polymeric fiber is an aramid or ultra high molecular weight polyethylene fiber.

19. The ballistic resistant composite material of claim 15, wherein the two distinct types of polymeric fibers are aramid and polyethylene fibers.

20. The ballistic resistant composite material of claim 9, wherein the two distinct types of polymer fibers are provided in separate monolayers.

21. The ballistic resistant composite material of claim 20 wherein the polymer fibers are selected from the group consisting of a poly-(p-phenylene-benzobisoxazole), an aramid and a polyethylene fiber.

22. The ballistic resistant composite material of claim 20 wherein at least one monolayer comprises poly-(p-phenylene-benzobisoxazole) fiber bonded by an elastomeric matrix to at least one additional monolayer comprising a different polymeric fiber.

23. The ballistic resistant composite material of claim 22 wherein the polymeric fiber of the at least one additional monolayer comprises an aramid or ultra high weight polyethylene fiber.

24. The ballistic resistant composite material of claim 20, wherein the at least two distinct types of polymeric fibers are aramid and polyethylene fibers.

25. The ballistic resistant composite material of claim 9, wherein the elastomeric matrix comprises about 8% to 17% by weight of an elastomeric material calculated on the basis of the total weight of the matrix.

26. The ballistic resistant composite material according to claim 9, wherein the elastomeric material is a styrene-isoprene-styrene block copolymer.

27. The ballistic resistant composite material according to claim 9, wherein the two distinct types of polymeric fibers are arrayed in an alternating or substantially alternating fashion in the same plane.

28. The ballistic resistant composite material according to claim 20, wherein the two distinct types of monolayers are arrayed in an alternating or substantially alternating fashion.

29. The ballistic resistant composite material according to claim 12, wherein the plurality of monolayers comprise at least two adjacent monolayers comprising PBO.

30. The ballistic resistant composite material according to claim 12, wherein the two distinct types of monolayers are arrayed in a sequence of aramid-PBO-PBO-aramid.

31. The ballistic resistant composite material according to claim 12, wherein PBO comprises approximately 20-80% of said material.

32. A body armor comprising the ballistic resistant composite material according to claim 9.

33. The body armor according to claim 32, wherein the fiber content in each monolayer is between 10 and 200 g/m².

34. A method for manufacturing the ballistic resistant composite material according to claim 1, comprising producing at least one monolayer comprising two distinct types of ballistic resistant polymeric fibers arranged in an alternating or substantially alternating fashion, including the steps of orienting said fibers unidirectionally in parallel in a plane, and wetting the fibers with a liquid comprising an elastomeric material to fix the position of the fibers in the monolayers.

35. A ballistic resistant material produced by the method of claim 34.

36. The ballistic resistant material according to claim 35, having a V50 value for a 9 mm full metal jacket 124 grain bullet of 1500 to 1700 f/sec.

37. The ballistic resistant material according to claim 36, having a weight of no more 3.8 kg/m².

38. The ballistic resistant composite material according to claim 37 wherein the two distinct polymeric fibers include one that is a poly-(p-phenylene-benzobisoxazole) fiber and one that comprises an aramid or ultra high weight polyethylene fiber, and wherein the elastomeric material is a styrene-isoprene-styrene block copolymer.

39. A method for manufacturing a ballistic resistant composite material according to claim 9, which comprises: producing at least one monolayer comprising a first type of unidirectional ballistic resistant polymeric fibers, and wetting those fibers with a liquid comprising an elastomeric matrix material to fix the position of those fibers; and producing at least one additional monolayer comprising orienting a distinct second type of ballistic resistant polymeric fibers at an angle to the fibers in the first monolayer and wetting those fibers with a liquid comprising an elastomeric material to fix the position of those fibers.

40. A method for manufacturing a ballistic resistant composite material comprising at least two
distinct types of monolayers arranged in an alternating or substantially alternating fashion, each monolayer comprising unidirectionally oriented fibers in an elastomeric matrix so that the fibers in each monolayer are positioned at an angle to the fibers in an adjacent monolayer, wherein each monolayer comprises at least one type of polymeric fibers, contains about 8% to 17% by weight of an elastomeric material calculated on the basis of the total weight of the monolayer, has a total weight of about 20 g/m² to about 250 g/m², and the fiber content in each monolayer is between about 10 and about 200 g/m², the method comprising the steps of producing at least two distinct adjacent monolayers comprising at least two distinct ballistic resistant polymeric fibers and wetting each monolayer with a liquid dispersion comprising an elastomeric matrix material to fix the position of the fibers therein.

41. A ballistic resistant composite material produced by the method of claim 40.

42. The ballistic resistant composite material according to claim 41, having a V50 value for a 9 mm full metal jacket 124 grain bullet of 1500 to 1700 f/sec.

43. The ballistic resistant composite material according to claim 42, having a weight of no more 3.8 kg/m².

44. The ballistic resistant composite material according to claim 43 wherein the two distinct polymeric fibers include one that is a poly-(p-phenylene-benzobisoxazole) fiber and one that comprises an aramid or ultra high weight polyethylene fiber, and wherein the elastomeric material is a styrene-isoprene-styrene block copolymer.
